(19) United States
(12) Patent Application Publication
(10) Pub. No.: US 2017/0275043 A1
(43) Pub. Date: Sep. 28, 2017

(54) CONTAINER COMPRISING A SINGLE-PIECE HEAD SECTION

(71) Applicant: KOCHER-PLASTIK MASCHINENBAU GMBH, Sulzbach-Laufen (DE)

(72) Inventor: Bernd HANSEN, Sulzbach-Laufen (DE)

(21) Appl. No.: 15/510,722

(22) PCT Filed: Sep. 10, 2015
(86) PCT No.: PCT/EP2015/001823

§ 371 Date: Mar. 13, 2017

(30) Foreign Application Priority Data
Oct. 31, 2014 (DE) 10 2014 016 192.7
Nov. 26, 2014 (CN) 201420720014.6

(51) Int. Cl. B65D 1/02

(52) U.S. Cl. CPC B65D 1/0238; B65D 1/0246; B65D 1/0276; B29C 49/00

(57) ABSTRACT

The invention relates to a container, which consists in particular of a plastic material, is produced using a blow-fill-seal method, and comprises a container body (1) for receiving a fluid as well as a neck section (5) that is connected to said container body (1) and has, at its free end, a dispensing opening (13) for said fluid which is sealed, via a separating region (15, 19), with a head section (17) that can be removed from the neck section (5) by actuating a movable sleeve section (35), by releasing the separating region (15, 19) such that said dispensing opening (13) is exposed. The invention is characterized in that, from the unactuated state to the actuated state in which the separating region (15, 19) is released, the sleeve section (35) is guided so as to be at least partially in contact with a guide path (23) that is part of the removable head section (17).

The invention relates to a container, which consists in particular of a plastic material, is produced using a blow-fill-seal method, and comprises a container body for receiving a fluid as well as a neck section that is connected to the container body and has, on its free end, a dispensing opening for the fluid that is sealed, via a separating region, with a head section that can be removed from the neck section by actuating a movable sleeve section, by releasing the separating region such that the dispensing opening is exposed.

Plastic containers that are produced using a blow-fill-seal method (BFS method) such as the one described in EP 2 269 558 A1 and also known in the industry by the name “bottelpack® System” are used for foods and beverages as well as in the medical field with great advantage for packaging pharmaceuticals, diagnostic materials, enteral nutrition, and medicinal products such as flushing and dialysis solutions, and the like. The embodiment of the container neck section and of the head section that seals the access opening on the neck section as a single piece in the blow mold method has the advantage that the container contents only contact a polymer that forms the container material, which polymer is typically a plastic such as LDPE, HDPE, or PP. The low germ count/sterility of the container contents can thus be ensured in containers produced and filled in this manner.

The separating region, via which the head section is formed on the neck section, is configured in such containers as a predetermined breaking point at which the head section can be released from the neck section for an extraction process. In order to enable the user to release the separation region reliably and conveniently, U.S. Pat. No. 4,176,755 has already disclosed a container of the aforementioned type, which has, as an opening or tearing aid, an actuation element in the form of a sleeve section that the user can actuate and that, in its standby position, surrounds the neck section and at least parts of the head section in the nature of an outer ring, which the user can actuate and which, in an actuated state, releases the separating region by tearing open the predetermined breaking point.

On the basis of this prior art, the invention addresses the problem of further improving a container of this type in terms of particularly good performance characteristics.

According to the invention, this problem is solved by a container that has the features of claim 1 in its entirety.

Accordingly, an essential unique feature of the invention lies in the fact that from the unactuated state to the actuated state in which the separating region is released, the sleeve section is guided so as to be at least partially in contact with a guide path, which is a part of the removable head section. As a result of this, the sleeve section is aligned coaxially to the head section such that compared to the aforementioned prior art, a more uniform load is applied to the separating region during the release. A reliable tearing open process is thus ensured over the entire circumference of the access opening, even for relatively large diameter access openings with correspondingly wide separating regions.

In advantageous fashion, for actuating the sleeve section provision can be made of a male thread arranged on the neck section, and of a female thread on the sleeve section that can be brought into engagement with said male thread, wherein by screwing the sleeve section, the separating region can be released and the dispensing opening exposed. By means of a screwing process it is possible to generate, in a particularly convenient manner, relatively strong actuation forces so that the container according to the invention is particularly convenient and effortless for the user to manipulate.

With particular advantage, the arrangement can be made such that when the sleeve section is screwed on, the separating region can be released such that a contact shoulder of the sleeve section in contact with the head section entrains the latter in order to release the separating area.

In particularly advantageous exemplary embodiments, the sleeve section has flexible contact fingers on its free end face, which engage in an underhand grip with a projection on the head section as the sleeve section is screwed on. Thus the sleeve section can be brought, by partially screwing it on, into a standby position in which the sleeve section is secured on, but still twistable in relation to, the head section by the contact fingers clicking in place. After carrying out an extraction process by screwing on the sleeve section further, during a subsequent unscrewing of the sleeve section the contact fingers entrain the head section detached from the separating region, wherein the head section is undetachably secured to the sleeve section after the latter is removed.

In order to give the user the option of carrying out an extraction process by screwing the sleeve section on as well as by unscrewing it, the arrangement can be made such that by unscrewing the sleeve section with the separating region not released, the contact fingers, which are engaged in an underhand grip with the projection of the head section, entrain the latter and release the separating region.

With particular advantage, the guide path for the actuation movements of the sleeve section can be formed on the outside of a ring collar which surrounds the head section and which extends between the separating region and an annular groove, which annular groove forms the space on the head section for receiving the contact fingers. A partition wall of the annular groove is thus available as an extensive ledge for supporting the contact fingers. The outer diameter of the ring collar can correspond to the inner diameter of the neck section in the region of its male thread, and the ring collar can have an axial extension, the length of which corresponds to the axial length of the annular groove, measured over its smallest diameter size.

In particularly advantageous exemplary embodiments, with the contact fingers of the sleeve section engaged in an underhand grip with the projection of the head section, an allocatable surface of the sleeve section is in full contact with the guide path, wherein the contact shoulder of the sleeve section overlaps the end of the ring collar at the upper end of the guide path. The contact surface of the sleeve section thus fully encompasses the ring collar of the head section such that when the actuation or tear-off force is transmitted via the contact shoulder, a counter-bearing is formed that prevents a radial deviation of the separation joint region of the head section under the effect of the actuation force and thus ensures a particularly reliable tearing off process.

For a particularly reliable transfer of the separation or tear-off force, a reinforcing rib projecting inwardly toward and connecting to the separating region can be present on the inner circumferential side of the ring collar. In cross section this reinforcing rib, at least when the sleeve section is unactuated, can form a wedge shape of which the longest cross leg in the direction of the neck section ends at the separating region and is arranged spaced parallel apart from another boundary line closing the reinforcing rib.

For a corresponding reinforcement on the opening edge of the neck section, the dispensing opening of the neck section can be bordered by an annular bulge, which protrudes above the separating region toward the unactuated sleeve section and abuts on the separating region with its largest cross sectional dimension.

The arrangement can furthermore be made such that the outer contour of the sleeve section is provided with a bevel toward the run-out of the contact fingers, which is adapted to an inclined position of the contact fingers. In the starting position in which the neck section is only partially screwed on, i.e. before reaching the standby position, the bevel of the sleeve section thus forms a continuous transition from the contact fingers to the upper surface of the head section that is essentially smooth and thus optically and haptically appealing.

The invention is explained in detail in the following, with reference to an exemplary embodiment illustrated in the drawings.

Shown are:

FIG. 1 a perspective oblique view, illustrated in approximately the natural size of a practical embodiment, of an exemplary embodiment of the container of the invention, with the opening-actuation element in the standby position;

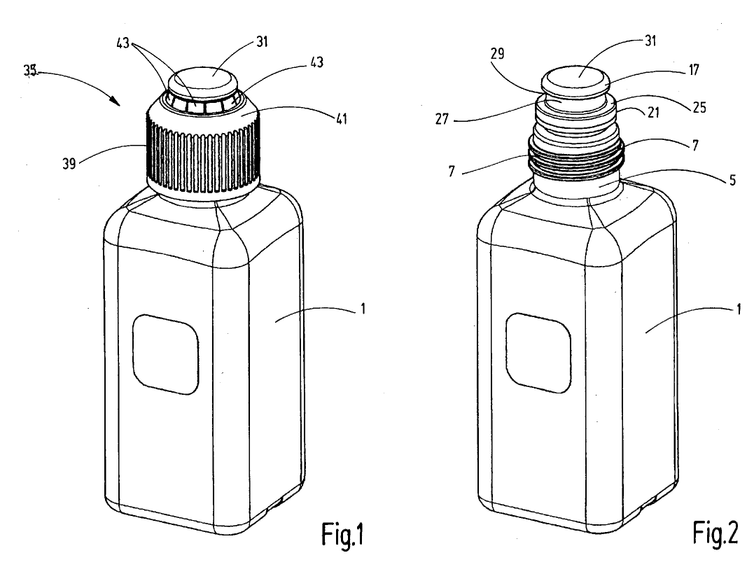

FIG. 2 an illustration corresponding to FIG. 1, in which the actuation element has been omitted;

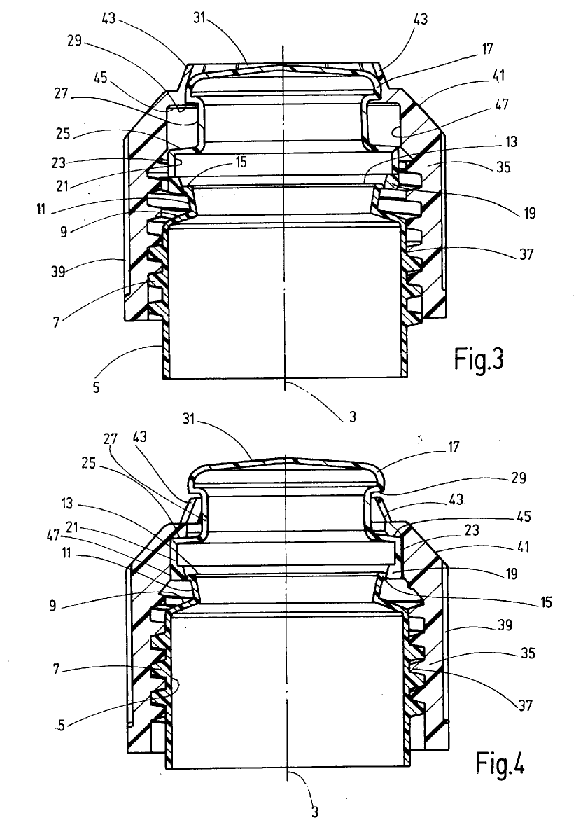

FIG. 3 a longitudinal section, drawn on a larger scale, of just the neck section and head section region of the container, in which the actuation element is shown in a partially screwed-on starting position;

FIG. 4 a longitudinal section corresponding to FIG. 3, in which the actuation element is illustrated in the standby position;

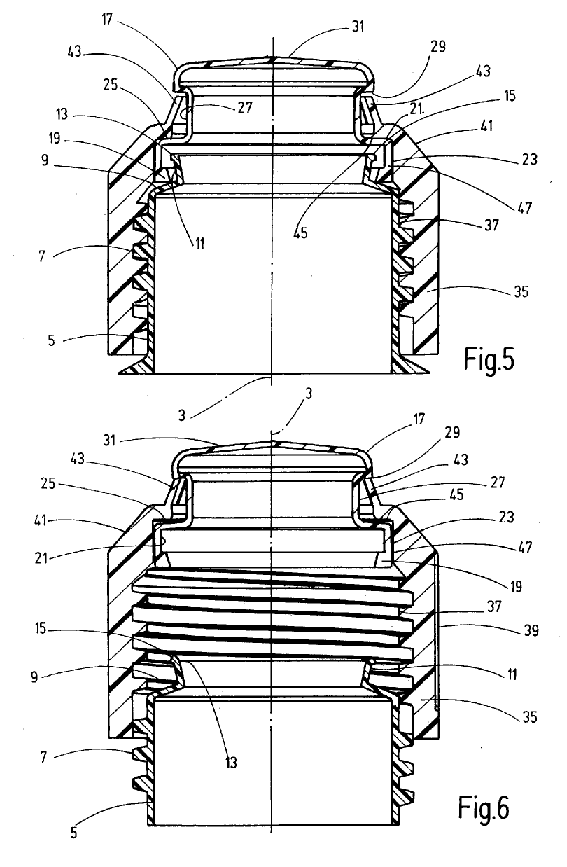

FIG. 5 a sectional view corresponding to FIGS. 3 and 4, in which the actuation element is illustrated in the screwed-on position after the opening of the container, and

FIG. 6 a corresponding sectional view, in which the actuation element is illustrated in a position in which it is partially unscrewed from the opened container.

As can be discerned from FIGS. 1 and 2, this exemplary embodiment of the container of the invention has a main container section 1 in the form of a plastic bottle which, with reference to a central main axis 3, possesses a square cross section with rounded corner regions and is designed with a 150 ml fill volume for receiving a fluid. As FIG. 2 most clearly shows, a neck section 5 coaxial to the axis 3 is molded onto the upper surface of the main section 1, the diameter of which neck section corresponds to roughly half the width of the main section 1 and the outside of which neck section is provided with a male thread 7 on ca. half of its length. As FIGS. 3-5 most clearly show, in its upper region the neck section 5 has, at a short axial distance from the uppermost winding of the male thread 7, an annular surface 9 that runs radially inwards and is upwardly inclined toward the axis 3, and transitions at the upper end into an end surface 11 that runs upwards and diverges outwards from the axis 3, the end edge of which end surface 11 surrounds the access opening 13 of the neck section 5. An edge bulge 15 that protrudes slightly outwards is thus formed on the edge of the access opening 13. As a sealing section for the access opening 13, a head section 17 is molded on the edge of said access opening 13 as an integral part of the neck section 5, wherein the edge bulge 15 and a reinforcing rib 19, which is located on the front-facing end of the head section 17, jointly form a separating region in which the junction point between the edge bulge 15 and the reinforcing rib 19 forms a predetermined breaking point, at which the head section 17 can be detached from the neck section 5 in order to expose the access opening 13 for an extraction process. The reinforcing rib 19 is present as a wedge-shaped, radially inward-extending projection on the end of a ring collar 21, the outside of which forms an outer cylinder surface 23, on the upper end of which is formed a step surface 25 that borders the radial length of said outer cylinder surface 23 and that extends radially inwards into an adjoining annular groove 27 of the head section 17. The upper end of the annular groove 27 is delimited by a flange-shaped radially outward-extending projection 29, which transitions into the upper end surface 31 of the head section 17.

As a tearing-off aid for releasing the head section 17 at the predetermined breaking point formed at the separating region 15, 19, a sleeve section 35 can be screwed onto the male thread 7 of the neck section 5, said sleeve section 35 possessing a female thread 37 in a circular cylindrical longitudinal section and a longitudinal riffle 39 on the outside. A sloping surface 41 adjoins the circumferential section having the riffle 39, which sloping surface 41 reduces the outer diameter of the neck section 35 toward the upper free end face. Starting from the sloping surface 41, a ring of contact fingers 43 extends to the upper end face, wherein the contact fingers 43 are inclined toward the axis 3. In the region between the sloping surface 41 and the contact fingers 43, the neck section 43 forms an inside contact shoulder 45 in the form of an annular surface lying in a radial plane.

FIG. 3 shows the sleeve section 35 in a starting position in which it is only partially screwed on, in which the contact shoulder 45 is located at a distance from the step surface 25 on the ring collar 21 and the contact fingers 43 extend to the upper end surface 31 of the head section 17. FIG. 4 shows the state in which the sleeve section 35, after being screwed on further, is in a standby position in which the contact fingers 43 are snapped into the annular groove 27 of the head section 17 beneath the projection 29. The sleeve section 35 has moved sufficiently far downwards such that a circular cylindrical inner contact surface 47 located in the region of the sloping surface 41 on the sleeve section 35 is in full contact with the outer cylinder surface 23 of the ring collar 21. The outer cylinder surface 23 thus forms a guide path for the sleeve section 35, on which said sleeve section 35 is guided in its axial movement as it is being screwed on. As it is being screwed on further from the standby position shown in FIG. 4 to the opening position shown in FIG. 5, in which the contact surface 47 of the sleeve section 35 slides on the guide wall formed by the outer cylinder surface 23 of the ring collar 21, the contact shoulder 45 of the sleeve section 35, which overlaps the step surface 25 of the ring collar 21, entrains the head section 17 such that the predetermined breaking point tears at the separating region 15, 17 and the access opening 13 is exposed (see FIG. 5, in which this state is illustrated).

FIG. 6 shows the sleeve section 35 in a position in which said sleeve section 35 is partially unscrewed from the position shown in FIG. 5 after the opening or tearing-off process. During this axial movement, the head section 17 is entrained by the underhand grip of the contact fingers 43 on the projection 29 such that when the sleeve section 35 is completely unscrewed, the head section 17 is removed together with the sleeve section 35 and is thus undetachably secured to the removed sleeve section 35. Should a subsequent closing of the bottle be desired, the head section 17 is thus available without any intervention on the user's part for being screwed back on together with the sleeve section 35. Because the inner contact surface 47 of the sleeve section 35 is in full contact with the outer cylinder surface 23 of the ring collar 21 that forms the guide path, a counter-bearing can be formed for the ring collar 21, and the access opening 13 can be resealed by tightening the screw connection and by the reinforcing rib 19 contacting the annular surface 9 of the neck section 5 (see FIG. 5).

If the contact fingers 43 are configured as sufficiently rigid, the opening process can also be carried out by unscrewing the sleeve section 35 from the standby position (FIG. 4), wherein during the upwards-running axial movement, the contact fingers 43 in underhand grip with the projection 29 entrain the head section 17 for an upwards-running shearing movement.

1. A container, consisting in particular of a plastic material and produced using a blow-fill-seal method, comprising a container body (1) for receiving a fluid as well as a neck section (5) that is connected to the container body (1) and has, at its free end, a dispensing opening (13) for said fluid that is sealed, via a separating region (15, 19), with a head section (17) that can be removed from the neck section (5) by actuating a movable sleeve section (35), by releasing the separating region (15, 19) such that the dispensing opening (13) is exposed, characterized in that, from the unactuated state to the actuated state in which the separating region (15, 19) is released, the sleeve section (35) is guided so as to be at least partially in contact with a guide path (23) that is part of the removable head section (17).

2. The container according to claim 1, characterized in that, for actuating the sleeve section (35), provision is made of a male thread (7) arranged on the neck section (5) and of a female thread (37) on the sleeve section (35) that can be brought into engagement with said male thread (7), and that, by screwing the sleeve section (35), the separating region (15, 19) can be released and the dispensing opening (13) exposed.

3. The container according to claim 1, characterized in that the separating region (15, 19) can be released with the screwing of the sleeve section (35) and further characterized in that a contact shoulder (45) of the sleeve section (35) in contact with the head section (17) entrains the latter so as to release the separating region (15, 19).

4. The container according to claim 1, characterized in that the sleeve section (35) has flexible contact fingers (43) on its free end face, which engage in an underhand grip with a projection (23) on the head section (17), and which, with the separating region (15, 19) released, entrain the head section (17) as the sleeve section (35) is being unscrewed.

5. The container according to claim 1, characterized in that, by unscrewing the sleeve section (35) with the separating region (15, 19) not released, the contact fingers (43) engaged in an underhand grip with the projection (24) of the head section (17) entrain the latter and release the separating region (15, 19).

6. The container according to claim 1, characterized in that the guide path is formed on the outside (23) of a ring collar (21), which surrounds the head section (17) and which extends between the separating region (15, 19) and an annular groove (27) that forms the space on the head section (17) for receiving the contact fingers (43).

7. The container according to claim 1, characterized in that the outer diameter of the ring collar (21) corresponds to the inner diameter of the neck section (5), in the region of its male thread (7).

8. The container according to claim 1, characterized in that the ring collar (21) has an axial extension, the length of which corresponds to the axial length of the annular groove (27), measured over the smallest diameter size thereof.

9. The container according to claim 1, characterized in that, with the contact fingers (43) of the sleeve section (35) engaged in an underhand grip with the projection (29) of the head section (17), an allocatable contact surface (47) of the sleeve section (35) is in full contact with the guide path (23) of the ring collar (21) and that the contact shoulder (45) of the sleeve section (35) overlaps the end (25) of the ring collar (21) at the upper end of the guide path (23).

10. The container according to claim 1, characterized in that a reinforcing rib (19) that projects inwardly toward and connects to the separating region (15, 19) is present on the inner circumferential side of the ring collar (21).

11. The container according to claim 1, characterized in that, at least with the sleeve section (35) unactuated, the reinforcing rib (19) is wedge-shaped in cross section, wherein the longest cross leg of the wedge in the direction of the neck section (5) ends at the separating region (15, 19) and is spaced parallel apart from another boundary line (19) closing the reinforcing rib (19).

12. The container according to claim 1, characterized in that the dispensing opening (13) of the neck section (5) is delimited by an annular bulge (15), which projects over the separating region (15, 19) toward the unactuated sleeve section (5) [sic] and borders the separating region (15, 19) with its largest cross-sectional dimension.

13. The container according to claim 1, characterized in that the outer contour of the sleeve section (35) is provided with a bevel (41) in the direction of the run-out of the contact fingers (43), which is adapted to an inclined position of the contact fingers (4).
